(19) United States
(12) Patent Application Publication
(10) Pub. No.: US 2011/0236269 A1
(43) Pub. Date: Sep. 29, 2011

(54) MICROREACTOR

(75) Inventors: Yasunobu Inoue, Niigata (JP); Hiroshi Nishiyama, Niigata (JP); Ryuusuke Asari, Niigata (JP)

(73) Assignee: National University Corporation Nagaoka University of Technology, Nagaoka-shi, Niigata (JP)

(21) Appl. No.: 13/119,143

(22) PCT Filed: Sep. 14, 2009
(86) PCT No.: PCT/JP2009/066042

§ 371 Date: May 12, 2011

(30) Foreign Application Priority Data
Sep. 20, 2008 (JP) 2008-241872

(51) Int. Cl. B01J 19/00

(52) U.S. Cl. 422/127

(57) ABSTRACT

A microreactor having a reaction mixture inlet, a reaction mixture channel, and a reaction mixture outlet is provided, in which a piezoelectric material that generates surface acoustic waves and has, formed on the surface thereof, a thin film having catalytic activity is disposed in the reaction mixture channel so that the inner surface of the reaction mixture channel is configured from the thin film. The thin film having catalytic activity can be constituted of a material selected from a group consisting of metals, metal oxides, and complexes of organic compounds. The microreactor attains remarkable improvements in the effect of stirring a reaction mixture and catalysis, whereby a chemical reaction can be evenly and efficiently accelerated. The microreactor is free from channel clogging and pressure loss and hence renders a stable and precise chemical reaction possible.

### TECHNICAL FIELD

The present invention relates to a microreactor capable of efficiently accelerating a chemical reaction.

### BACKGROUND ART

In recent years, there have been proposed various microreactors that perform, by employing microprocessing technologies, chemical reactions in microchannels formed in members such as a glass substrate, a metal substrate, a resin substrate, and a silicon substrate.

Investigations have been conducted on the application of the chemical reactions performed in microspaces with the microreactors to various fields because the chemical reactions each have the following advantages.

(1) The space is small, and hence the diffusion length of a molecule becomes short. As a result, molecular transport such as mixing or extraction occurs quickly. Therefore, a reaction time and a time required for the process can be shortened.

(2) The efficiency of a phenomenon in which an interface between liquids, or a liquid and a solid, which react with each other is involved is accelerated because the specific surface area of a reactor (area of the interface per volume) is large.

(3) The inside of the reactor has a small heat capacity, and hence a heat exchange can be rapidly performed. Therefore, the temperature of the chemical reaction can be easily controlled.

As the chemical reactions with the microreactors each involve the treatment of a reaction solution having a volume of the order of 10⁻⁶ l, the reaction solution cannot be stirred with conventional stirring means. In view of the foregoing, various means for accelerating the chemical reactions in the microreactors have been proposed (see, for example, Patent Documents 1 to 3).
[Patent Document 1] JP 2004-313867 A
[Patent Document 2] JP 2007-90306 A
[Patent Document 3] JP 2004-195433 A

The technology described in Patent Document 1 aims to stir the reaction solution by contriving a shape and arrangement of a channel provided in a microreactor. However, the technology involves the following drawbacks. The channel clogging and pressure loss of the microreactor are induced.

In addition, the technologies described in Patent Documents 2 and 3 each involving the use of vibrating means each result in the generation of pulsation in the reaction solution. As a result, the following problem arises. A chemical reaction becomes uneven.

Various microreactors each provided with a piezoelectric material that generates a travelling wave by applying a voltage to the wall surface of a channel have also been proposed as means for accelerating the chemical reactions in the microreactors (see, for example, Patent Documents 4 to 6).
[Patent Document 4] JP 2008-36485 A
[Patent Document 5] JP 2005-224746 A
[Patent Document 6] JP 2004-184315 A

As illustrated in FIG. 8, in the microreactor described in Patent Document 4, a channel 13′ of the microreactor is formed of a piezoelectric material 1′ obtained by providing the outer surface of a substrate formed of a lithium niobate (LiNbO₃) single crystal with comb type electrodes 4′. In the microreactor, the energy of a travelling wave (Rayleigh wave) generated from the piezoelectric material 1′ concentrates on a depth within one wavelength from the surface of the substrate, and hence the thickness of the substrate is required to be equal to or smaller than the one wavelength. Meanwhile, the wavelength of the Rayleigh wave that propagates through the surface of the substrate formed of the lithium niobate single crystal and a frequency to be applied have a relationship illustrated in FIG. 9. Therefore, the thickness of the substrate is required to be about 200 μm or less in order that a reaction may be performed by applying a frequency of 20 MHz or more to the piezoelectric material 1′ in the microreactor. However, the substrate formed of the LiNbO₃ single crystal is so apt to splinter as to be difficult to machine. Accordingly, no microreactor channels that can be put into practical use can be formed from substrates each having such thickness.

In addition, none of the microreactors described in Patent Documents 5 and 6 can sufficiently improve the efficiency of a chemical reaction in a channel because each of the microreactors is such that a piezoelectric material is provided for the outer wall surface of the channel.

Therefore, in each of the microreactors described in Patent Documents 4 to 6 listed above, it has been difficult to improve the efficiency of a chemical reaction in the reactor to a practical level. Accordingly, a microreactor with its reaction efficiency more improved has been required.

### DISCLOSURE OF THE INVENTION

### Problems to be Solved by the Invention

Therefore, an object of the present invention is to provide a microreactor capable of homogeneously and efficiently accelerating a chemical reaction without causing channel clogging or pressure loss.

### Means for Solving the Problems

The inventors of the present invention have found that the above-mentioned problems are solved by forming the inner surface of the reaction mixture channel of a microreactor with a piezoelectric material that generates surface acoustic waves, the piezoelectric material having a thin film having a catalytic action formed on its surface. Thus, the inventors have completed the present invention.

That is, the present invention adopts the following configurations 1 to 8.

1. A microreactor, comprising: a reaction mixture inlet; a reaction mixture channel; and a reaction mixture outlet, in which a piezoelectric material that generates surface acoustic waves, the piezoelectric material having formed on a surface thereof a thin film having a catalytic action, is placed in the reaction mixture channel so that the thin film forms the inner surface of the reaction mixture channel.

2. The microreactor as described in the item 1, in which the piezoelectric material includes comb type electrodes placed at both ends in the length direction of the piezoelectric material, and the thin film having a catalytic action formed between the comb type electrodes.

3. The microreactor described in the item 1 or 2, in which the thin film having a catalytic action is formed of a material selected from the group consisting of metals or metal oxides and organic compound complexes.

4. The microreactor as described in the item 3, in which the thin film having a catalytic action is formed of a plurality of layers.

5. The microreactor described in the item 4, in which the thin film having a catalytic action has a molybdenum layer adjacent to the surface of the piezoelectric material and a surface layer formed of indium.

6. The microreactor as described in any one of the items 1 to 5, in which the thin film having a catalytic action has a thickness of 1 nm to 10 μm.

7. The microreactor as described in any one of the items 1 to 6, in which the piezoelectric material includes a piezoelectric material that generates a Rayleigh wave.

8. The microreactor as described in any one of the items 1 to 6, in which the piezoelectric material includes a piezoelectric material that generates a bulk wave and an SH wave at the same time.

### Advantageous Effects of the Invention

The microreactor of the present invention can homogeneously and efficiently accelerate a chemical reaction because a stirring effect and a catalytic action on a reaction mixture are remarkably improved in the microreactor. In addition, the microreactor can realize a stable, precise chemical reaction without causing channel clogging or pressure loss.

### BRIEF DESCRIPTION OF THE DRAWINGS

FIG. 1 is a view illustrating an example of a microreactor of the present invention, the figure being a schematic view illustrating a state before the assembly of members of which the microreactor is formed.

FIG. 2 is a front view illustrating a state after the assembly of the microreactor illustrated in FIG. 1.

FIG. 3 is an enlarged schematic sectional view of the main portion of the microreactor illustrated in FIG. 1.

FIG. 4 is a schematic view illustrating an example of an SAW device on which a thin film having a catalytic action is formed, the device being used in the microreactor of the present invention.

FIG. 5 is a schematic view illustrating another example of the SAW device on which the thin film having a catalytic action is formed, the device being used in the microreactor of the present invention.

FIG. 6 is a photograph of the external appearance of the SAW device before the formation of the thin film, the device being used in the microreactor of the present invention.

FIG. 7 is a schematic view illustrating another example of the microreactor of the present invention.

FIG. 8 is a schematic sectional view of the channel of a conventional microreactor.

FIG. 9 is a view illustrating a relationship between the frequency and wavelength of a Rayleigh wave that propagates through the surface of lithium niobate.

### DESCRIPTION OF SYMBOLS

1 lower member
2, 7 recessed portion
3, 1′ piezoelectric material
4, 13′ channel
5 gasket
6 upper member
8 electrical porcelain
9 lid
10 thin film having catalytic action
11 raw material inlet
12 reaction mixture outlet
13 contact probe pin
14, 4′ comb type electrode
15, 16 reaction mixture guidepath
101, 201 microreactor

### BEST MODE FOR CARRYING OUT THE INVENTION

Next, a specific embodiment of the present invention is described with reference to the drawings. However, the following specific examples do not limit the present invention.

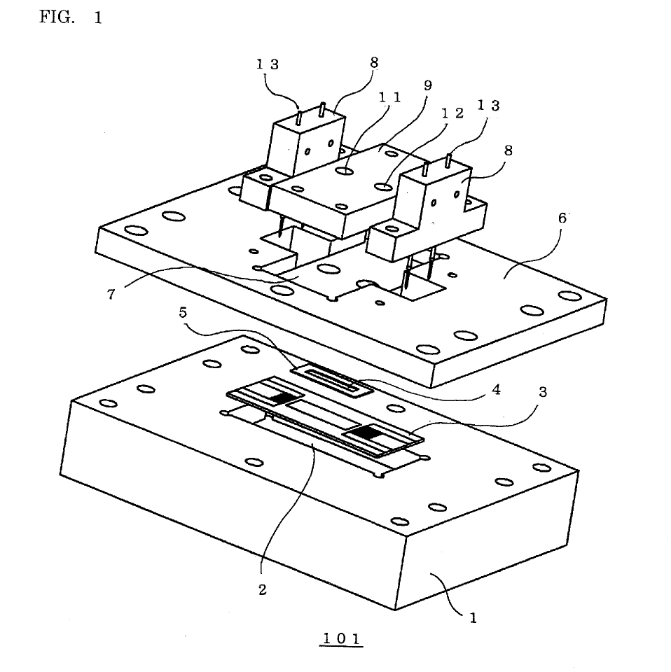

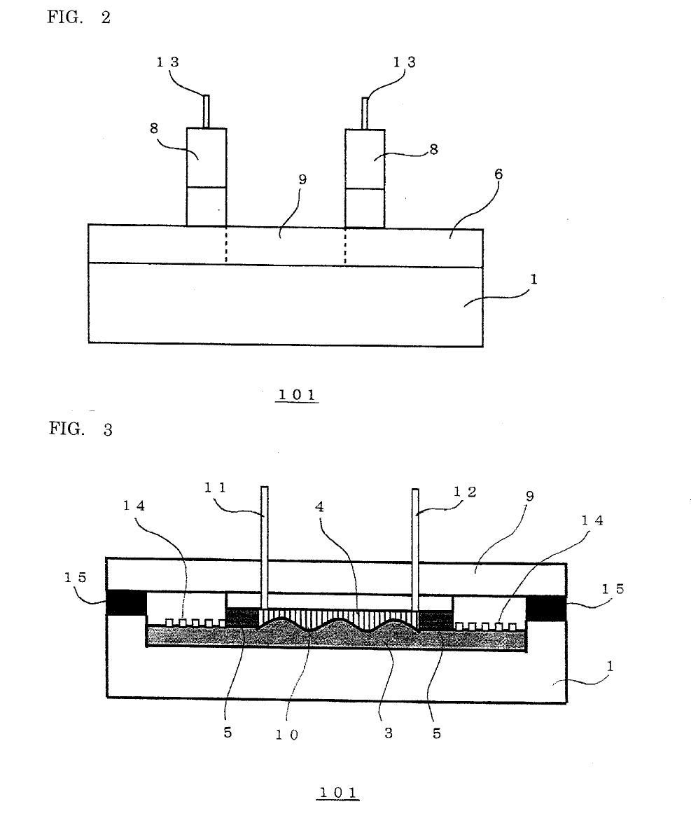

FIGS. 1 to 3 are each a schematic view illustrating an example of a microreactor of the present invention. FIG. 1 is a perspective view illustrating a state before the assembly of members of which the microreactor is formed, FIG. 2 is a front view of the microreactor after the assembly of the microreactor, and FIG. 3 is a schematic sectional view of the main portion of the microreactor.

The microreactor 101 is formed by screwing a lower member 1 formed of a material such as stainless steel, a piezoelectric material 3 that generates surface acoustic waves (SAWs), the piezoelectric material being stored in a recessed portion 2 provided for the lower member 1, a gasket 5 provided with a channel 4 at its central portion, an upper member 6 formed of a material such as stainless steel and provided with a recessed portion 7, electrical porcelains 8 and 8, and a stainless steel lid 9 stored in the recessed portion 7 through threaded holes provided for the respective members.

The lid 9 is provided with an inlet 11 through which a raw material is introduced into the channel 4 of the microreactor and an outlet 12 from which a reaction mixture is led. In addition, a total of four contact probe pins 13 for applying high-frequency power are placed in the electrical porcelains 8 and 8. In addition, as illustrated in FIG. 3, comb type electrodes 14 and 14 are placed on both sides of the piezoelectric material 3, and a thin film 10 having a catalytic action is formed between the comb type electrodes 14 and 14. A material of which the gasket 5 provided with the channel 4 is formed is not limited, and any one of the materials including synthetic rubbers and engineering plastics such as Viton rubber, polyimide, and Teflon (registered trademark), and metal foils made of stainless steel, aluminum, copper, and the like can be used.

The surface of the piezoelectric material 3 is provided with a thin film having a catalytic action formed of a material selected from the group consisting of metals such as palladium, platinum, and ruthenium, oxides of the metals, and organic compound complexes. Providing such thin film exerts a solid catalytic effect by which the efficiency of a chemical reaction in the microreactor is significantly improved.

A method of forming the thin film having a catalytic action on the surface of the piezoelectric material 3 is not particularly limited, and an ordinary method such as vapor deposition, sputtering, plating, or coating is employed. A preferred method of forming the thin film is, for example, vapor deposition when a metal thin film is formed or sputtering when a metal oxide thin film is formed. In addition, the preferred method is, for example, a method involving coating a solution prepared by dissolving an organic compound complex in a solvent when an organic compound complex thin film is formed.

Although the thin film having a catalytic action can be formed of a single layer, the thin film may be formed of a plurality of layers.

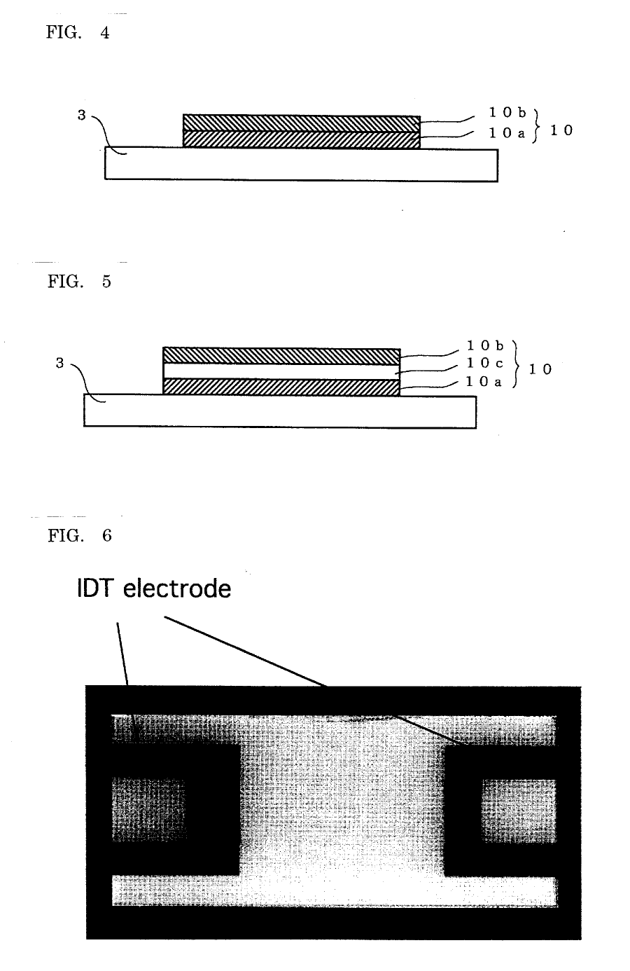

FIG. 4 is a schematic view illustrating an example in which the thin film having a catalytic action is formed of a plurality of layers. In this example, the thin film 10 having a catalytic action was formed by providing the surface of the piezoelectric material 3 with a first thin film layer 10a formed of a metal such as molybdenum or an oxide of such metal, and providing the surface of the first thin film layer with a surface layer 10b formed of a metal such as indium or an oxide of such metal.

In addition, FIG. 5 is a schematic view illustrating another example in which the thin film having a catalytic action is formed of a plurality of layers. In this example, the thin film 10 having a catalytic action was formed by providing the surface of the piezoelectric material 3 with the first thin film layer 10a formed of a metal such as molybdenum or an oxide of such metal, forming an intermediate layer 10c formed of a metal oxide such as tungsten oxide on the surface of the first thin film layer, and providing the surface layer 10b formed of a metal such as indium or an oxide of such metal on the intermediate layer 10c.

None of the first thin film layer 10a formed on the surface of the piezoelectric material 3 and the intermediate layer 10c themselves is necessarily needed to have a catalytic action. For example, when the thin film having a catalytic action poorly adheres to the surface of the piezoelectric material 3 like indium, and the resultant thin film is brittle and lacks durability, the first thin film layer 10a made of molybdenum or the like is preferably formed on the surface of the piezoelectric material 3. When the thin film 10 having a catalytic action is formed of a plurality of layers as described above, the durability and catalytic action of the reactor are additionally improved, and hence a chemical reaction can be efficiently performed with the microreactor.

A piezoelectric material capable of generating a bulk wave and an SH wave at the same time or a piezoelectric material that generates a Rayleigh wave is preferably used as the piezoelectric material 3 that generates surface acoustic waves (SAWs). In the microreactor 101 of the present invention, such product obtained by forming the thin film having a catalytic action on the surface of the piezoelectric material 3 as described above is used as a material of which the wall surface of the channel 4 (lower surface of the channel) is formed.

The SAWs have been conventionally insufficient means for stirring a reaction solution in a microreactor because the SAWs abruptly attenuate in a liquid. In the present invention, the catalytic action in the reactor can be significantly improved by using the piezoelectric material having the thin film having a catalytic action formed on its surface. In addition, when a displacement wave perpendicular to the surface of a reaction mixture is generated by using such piezoelectric material as described above, the SAWs propagate without attenuating in the reaction mixture to accelerate the stirring of the reaction mixture, and hence the chemical reaction progresses efficiently.

The dimensions of the channel of the microreactor of the present invention can be appropriately selected. In ordinary cases, the channel measures preferably about 100 to 5,000 μm and particularly preferably about 100 to 2,000 μm in width by preferably about 10 to 1,000 μm and particularly preferably about 100 to 1,000 μm in depth by preferably about 1 to 15 mm and particularly preferably about 5 to 15 mm in length.

Although, in the above-mentioned example, description has been given of the example in which the entirety of one wall surface of the channel 4 of the microreactor is formed of an SAW device including the thin film having a catalytic action formed on its surface, such a configuration that the SAW device is placed on part of the wall surface of the channel is also permitted. Alternatively, a plurality of wall surfaces may each be formed of the SAW device. The thin film having a catalytic action formed on the surface of the SAW device can be formed as a film that is continuous over the total length of the device. Alternatively, the thin film may be partially formed on the surface of the SAW device.

Any other material such as glass, a resin, silicon, or a fine ceramic as well as a metal such as stainless steel can be used in each member of which the microreactor is formed.

In addition, the number of each of the raw material inlet 11 and the reaction mixture outlet 12 provided to be connected to the channel 4 is not limited to one, and the plurality of raw material inlets 11 or reaction mixture outlets 12 may be provided. For example, as described in Patent Document 1 or 2, the microreactor can be formed by providing a plurality of raw material inlets, a plurality of reaction mixture guidepaths for causing the plurality of raw material inlets and a reaction channel to communicate with each other, the reaction channel, and one or more reaction mixture outlets.

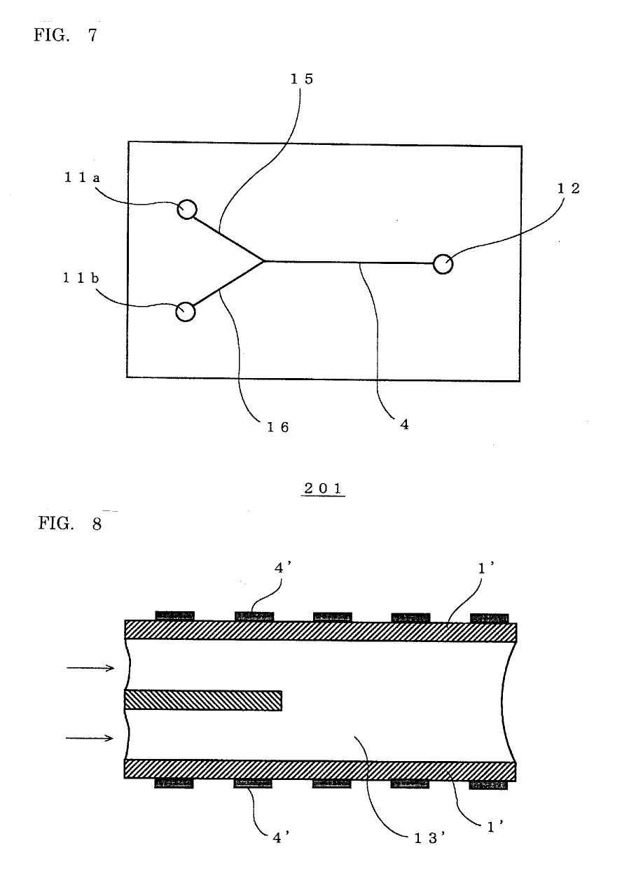

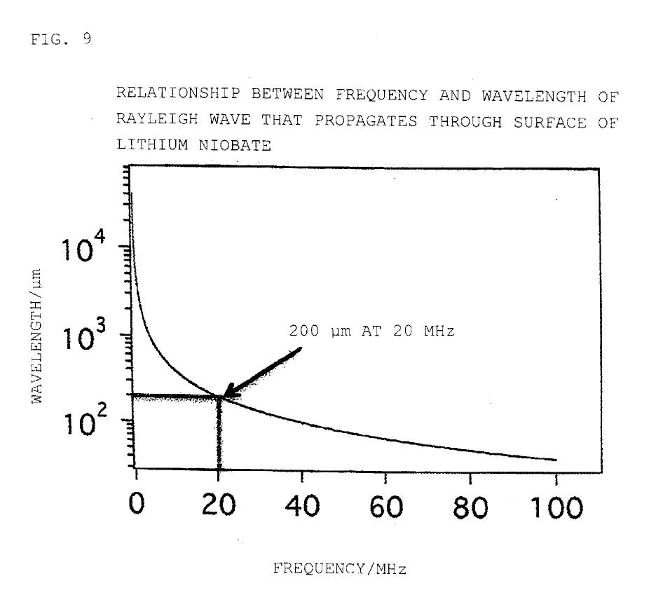

FIG. 7 is a schematic view illustrating another example of the microreactor of the present invention. The microreactor 201 is provided with two raw material inlets 11a and 11b, reaction mixture guidepaths 15 and 16 for introducing raw materials from these raw material inlets to the reaction channel 4, and the one reaction mixture outlet 12 for discharging the reaction mixture from the reaction channel 4. The other configuration of the microreactor is basically the same as that illustrated in each of FIGS. 1 to 3.

### EXAMPLES

### Production Example 1

### Production of SAW Device

An SAW device including dual comb type electrodes (IDT: Interdigital Transducer electrodes) and capable of generating a Rayleigh wave having a frequency of 19.4 MHz was produced with a z-cut, 128° y-rotated LiNbO₃ single crystal substrate (measuring 40 mm long by 20 mm wide) by an ordinary photolithography method according to the following procedure.

(1) The single crystal substrate was subjected to ultrasonic cleaning in ethanol and then in distilled water so that dust and dirt on the surface of the substrate were completely removed. After that, the substrate was dried in a drying machine at 358 K for about 30 minutes.
(2) An Al deposited film having a thickness of 200 nm was formed on the surface of the substrate with an electron beam deposition apparatus (EVC1501 manufactured by ANELVA) at a substrate temperature of 473 K, a degree of vacuum of 5×10⁻⁴ Pa, and a deposition rate of 3 nms⁻¹.
(3) The surface of the Al deposited film was coated with 2 ml of a commercially available positive type resist (OFPR-800 manufactured by TOKYO OHKA KOGYO CO., LTD.) with a spin coater (K-3595 D-1 manufactured by KYOWARIKEN CO., LTD.). After that, the resultant was pre-baked at 358 K for 30 minutes so that the solvent was evaporated.
(4) A photomask produced in advance and the substrate were set in a mask alignment apparatus (MA-60F manufactured by Mikasa corporation), and were then exposed to light from an ultra-high pressure mercury lamp having an output of 250 W for 6 seconds. Subsequently, the resultant was immersed in a developer (NMD-3 manufactured by TOKYO OHKA KOGYO CO., LTD.) kept at 298 K for 1 minute so that the exposed resist was developed. After having been washed with water, the resultant was post-baked at 373 K so that the resist was completely cured.
(5) The substrate was immersed in an 85% aqueous solution of phosphoric acid kept at 318 K so that etching was performed. Thus, unnecessary Al was removed. After the resultant had been washed with water, the resist was removed with acetone, and then the remainder was further washed with water.
(6) FIG. 6 is a photograph of the external appearance of the SAW device including IDT electrode patterns at both ends obtained by cutting the resultant into predetermined dimensions.

### Production Example 2

### SAW Device on which Thin Film Having Catalytic Action is Formed

A thin film having a catalytic action was formed on a device surface interposed between the IDT electrodes at both ends of the SAW device obtained in Production Example 1 according to the following procedure.

### (a) Molybdenum Film

A molybdenum thin film (having a thickness of 200 nm) was formed on the surface of the SAW device by using a helicon wave-excited sputtering apparatus “BC3285” manufactured by ULVAC, Inc. with molybdenum as a target under the following conditions.

The temperature of the SAW device: room temperature, the pressure of an argon gas: 1×10⁻² Torr, target power: 75 W.

### (b) Indium Film

An indium thin film (having a thickness of 100 nm) was formed on the surface of the SAW device by using a resistance heating deposition apparatus “YH-500A” manufactured by ULVAC, Inc. under the following conditions.

The temperature of the SAW device: room temperature, a pressure: 1×10⁻⁶ Torr.

### (c) WO₃ Film

A tungsten oxide thin film (having a thickness of 250 nm) was formed on the surface of the SAW device by using the helicon wave-excited sputtering apparatus “BC3285” manufactured by ULVAC, Inc. with WO₃ as a target under the following conditions.

The temperature of the SAW device: room temperature, the pressure of a mixed gas of argon and oxygen (volume ratio “Ar:O₂”=15:1): 1×10⁻⁶ Torr, target power: 75 W.

### (d) Molybdenum/Indium Composite Film

A molybdenum thin film (having a thickness of 200 nm) was formed on the surface of the SAW device at room temperature by using the resistance heating deposition apparatus “YH-500A” manufactured by ULVAC, Inc. at a pressure of 1×10⁻⁶ Torr. Subsequently, an indium thin film (having a thickness of 100 nm) was similarly deposited from the vapor onto the molybdenum thin film by using the resistance heating deposition apparatus “YH-500A” manufactured by ULVAC, Inc.

### (e) Molybdenum/Tungsten Oxide/Indium Composite Film

A molybdenum thin film (having a thickness of 200 nm) was formed on the surface of the SAW device by using the helicon wave-excited sputtering apparatus “BC3285” manufactured by ULVAC, Inc. at room temperature and an argon pressure of 1×10⁻² Torr. Subsequently, a tungsten oxide thin film (having a thickness of 250 nm) was formed at room temperature and a pressure of a mixed gas of argon and oxygen (volume ratio “Ar:O₂”=15:1) of 1×10⁻⁶ Torr. Next, the substrate taken out of the helicon wave-excited sputtering apparatus manufactured by ULVAC, Inc. was introduced into the resistance heating deposition apparatus “YH-500A” manufactured by ULVAC, Inc., and then an indium thin film (having a thickness of 100 nm) was joined to the surface of the tungsten oxide thin film in the same manner as in the above-mentioned section (b).

### (f) Organic Complex Catalyst: Film of Scandium Triflate Sc(OTf)₃

A 5-mol % solution of Sc(OTf)₃ in ethanol was prepared by dissolving Sc(OTf)₃ in ethanol. The solution was coated to the surface of the SAW device. Thus, the SAW device including an organic complex catalyst thin film formed on its surface was obtained.

### Example 1

### Production of Microreactors

The respective SAW devices obtained in the above-mentioned sections (a) to (f) of Production Example 2 were each incorporated into the microreactor 101 illustrated in each of FIGS. 1 to 3. Thus, microreactors each having the channel 4 measuring 2 mm in width by 250 μm in depth by 11 mm in length were produced. Connected to each of the microreactors were the raw material inlet 11 and the reaction mixture outlet 12 formed in the lid 9 and each having an inner diameter of 500 μm.

### Example 2

### Synthesis of 2-Phenyl-4-Penten-2-ol

The microreactor into which the SAW device including the molybdenum/indium composite film formed on its surface obtained in the above-mentioned section (d) of Production Example 2 was incorporated was used. 2-Phenyl-4-penten-2-ol was synthesized with acetophenone and allyl boronate as raw material substances in accordance with the following reaction formula. The indium film on the surface has a catalytic action on a reaction for synthesizing 2-phenyl-4-penten-2-ol.

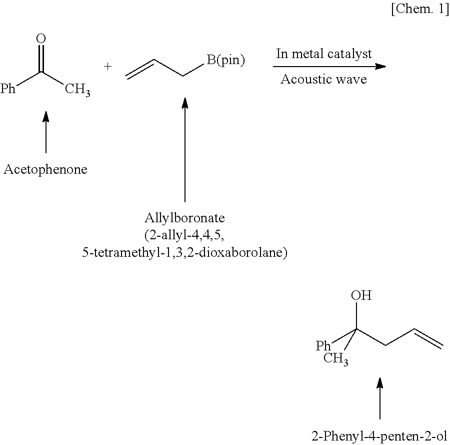

A solution prepared by mixing equal moles of acetophenone and allyl boronate was regarded as a raw material solution, and pure water was used as a solvent. A reaction mixture was prepared by mixing the raw material solution and the solvent solution at a volume ratio of 1:10. The reaction mixture was delivered with a syringe pump from the raw material inlet 11 of the microreactor into the channel 4 at a flow rate of 11 μl/min, and then a reaction was performed at room temperature. The amount in which 2-phenyl-4-penten-2-ol was produced was measured with a gas chromatograph mass spectrometer.

The rate of formation of 2-phenyl-4-penten-2-ol when the reaction was performed without the application of any surface acoustic wave was 18.8 μmol/min. On the other hand, the rate of formation of 2-phenyl-4-penten-2-ol when the reaction was similarly performed by applying a surface acoustic wave having a frequency of 20 MHz at an applied electric power of 10 W was 26 μmol/min. In other words, the rate of formation increased by a factor of about 1.4 as compared with that in the case where no surface acoustic wave was applied. In addition, the rate of formation reduced to 22 μmol/min when the reaction was performed in a state in which no surface acoustic wave was applied after the application of the surface acoustic wave.

### Comparative Example 1

2-Phenyl-4-penten-2-ol was synthesized in the same manner as in Example 2 described above except that the microreactor into which the SAW device including the molybdenum film formed on its surface obtained in the section (a) of Production Example 2 was incorporated was used in Example 2. The molybdenum film itself does not have any catalytic action on the reaction for synthesizing 2-phenyl-4-penten-2-ol.

The rate of formation of 2-phenyl-4-penten-2-ol when the reaction was performed without the application of any surface acoustic wave was 0.3 μmol/min. On the other hand, the rate of formation of 2-phenyl-4-penten-2-ol when the reaction was similarly performed by applying a surface acoustic wave having a frequency of 20 MHz at an applied electric power of 10 W was 0.4 μmol/min.

### Example 3

2-Phenyl-4-penten-2-ol was synthesized in the same manner as in Example 2 described above except that the microreactor into which the SAW device including the molybdenum/tungsten oxide/indium composite film formed on its surface obtained in the section (e) of Production Example 2 was incorporated was used in Example 2.

The rate of formation of 2-phenyl-4-penten-2-ol when the reaction was performed without the application of any surface acoustic wave was 44 μmol/min. On the other hand, the rate of formation of 2-phenyl-4-penten-2-ol when the reaction was similarly performed by applying a surface acoustic wave having a frequency of 20 MHz at an applied electric power of 10 W was 86 μmol/min. In other words, the rate of formation increased by a factor of about 2 as compared with that in the case where no surface acoustic wave was applied. In addition, the rate of formation reduced to 43 μmol/min when the reaction was performed in a state in which no surface acoustic wave was applied after the application of the surface acoustic wave.

As can be seen from comparison between Example 2 and Comparative Example 1 described above, the use of a microreactor into which an SAW device including an indium thin film having a catalytic action formed on its surface was incorporated resulted in a significant increase in rate of formation of 2-phenyl-4-penten-2-ol.

In particular, the microreactor of Example 3 using the SAW device including the molybdenum/tungsten oxide/indium composite film having tungsten oxide as an intermediate layer formed on its surface further increased the rate of formation of 2-phenyl-4-penten-2-ol.

### Reference Example 1

### Synthesis of Chalcone

A microreactor similar to that of Example 1 was produced by incorporating the SAW device provided with no thin film having a catalytic action on its surface obtained in Production Example 1. Chalcone (1,3-diphenyl-2-propen-1-one) was synthesized by using the microreactor with benzaldehyde and acetophenone as raw material substances in accordance with the following reaction formula.

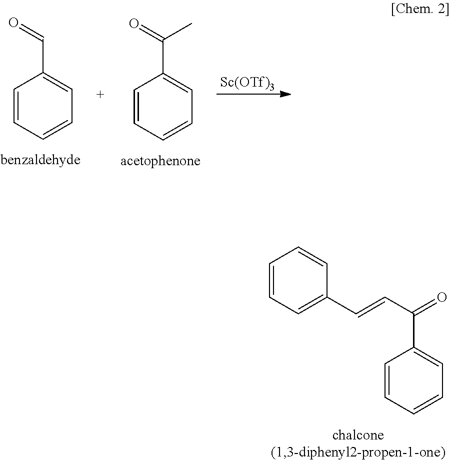

A solution prepared by mixing equal moles of benzaldehyde and acetophenone was regarded as a raw material solution, and the 5-mol % solution of scandium triflate Sc(OTf)₃ in ethanol was used as a catalyst solution. A solution prepared by mixing the catalyst solution and the raw material solution at a volume ratio of 15:1 was regarded as a reaction mixture. The reaction mixture was delivered with a syringe pump from the raw material inlet 11 of the microreactor into the channel 4, and then a reaction was performed. At that time, an effect of applying an SAW by the SAW device was observed as described below.

(1) Effect of Applying Rayleigh-SAW on Aldol Condensation Reaction Involving Use of Sc(OTf)₃

The reaction was performed under the conditions of an applied power of 5 W, a duty ratio of 50%, a flow rate of 1 μl/min, and a reaction temperature of 353 K.

While the rate of formation of chalcone in an SAW-off state was 42 μmol/h, the rate of formation in an SAW-on state was 120 μmol/h. In other words, the latter rate of formation increased by a factor of about 3 as compared with the former rate of formation. In addition, the rate of formation reduced to 25 μmol/h when the reaction was performed in the SAW-off state after the SAW-on state. The amount in which chalcone was produced was measured with a gas chromatograph mass spectrometer.

(2) Duty Ratio Dependence

When continuous (continuous-wave) high-frequency power is applied to a surface acoustic wave device to be typically used, a power of 5 W or more results in the breakage of the device. However, the use of a burst wave serving as a pulse wave enables the application of a high-frequency power of 10 W or more to the device. A ratio of the time period for which the high-frequency power is turned on to the time period for which the high-frequency power is turned off in the burst wave is called a duty ratio (the duty ratio is 50% when the ON and OFF time periods are exactly the same). The duty ratio dependence of a reaction was investigated.

The reaction was performed at an applied power of 5 W, a flow rate of 1 μl/min, a reaction temperature of 353 K, and a duty ratio of 20%, 50%, or 80%. As a result, a reaction rate ratio R was 1 at a duty ratio of 20%, the reaction rate ratio R was 2.6 at a duty ratio of 50%, and the reaction rate ratio R was 3.3 at a duty ratio of 80%.

(3) Applied Power Dependence

The reaction was performed at a duty ratio of 80%, a flow rate of 1 μl/min, a reaction temperature of 353 K, and an applied power of 2 W, 5 W, or 8 W. A reaction rate ratio R was 1.2 at an applied power of 2 W, the reaction rate ratio R was 3.1 at an applied power of 5 W, and the reaction rate ratio R was 4.3 at an applied power of 8 W.

(4) Effect of Applying SH-LSAW on Aldol Condensation Reaction Involving Use of Sc(OTf)₃ Catalyst

An SH-LSAW device capable of generating an SH wave was produced in the same manner as in Production Example 1 described above except that 36°-y cut LiTaO₃ was used as a single crystal substrate in Production Example 1. An effect of applying an SH-LSAW was investigated with the device.

The reaction was performed under the conditions of an applied power of 5 W, a duty ratio of 50%, a flow rate of 1 μl/min, and a reaction temperature of 353 K.

While the rate of formation of chalcone in an SAW-off state was 45 μmol/h, the rate of formation in an SAW-on state was 105 μmol/h. In other words, the latter rate of formation increased by a factor of about 2 as compared with the former rate of formation. In addition, the rate of formation reduced to 59 μmol/h when the reaction was performed in the SAW-off state after the SAW-on state.

### Example 4

Chalcone was synthesized in the same manner as in Reference Example 1 described above except that a microreactor into which the SAW device including the Sc(OTf)₃ film formed on its surface obtained in the section (f) of Production Example 2 was incorporated was used in Reference Example 1.

The rate of formation of chalcone when the reaction was performed without the application of any surface acoustic wave was 51.8 μmol/min. On the other hand, the rate of formation of chalcone when the reaction was similarly performed by applying a surface acoustic wave at an applied electric power of 10 W was 151 μmol/min. In other words, the rate of formation increased by a factor of about 3 as compared with that in the case where no surface acoustic wave was applied. In addition, the rate of formation reduced to 57 μmol/min when the reaction was performed in a state in which no surface acoustic wave was applied after the application of the surface acoustic wave.

1. A microreactor, comprising:
a reaction mixture inlet;
a reaction mixture channel; and
a reaction mixture outlet,
wherein a piezoelectric material that generates surface acoustic waves, the piezoelectric material having formed on a surface thereof a thin film having a catalytic action, is placed in the reaction mixture channel so that the thin film forms an inner surface of the reaction mixture channel.

2. A microreactor according to claim 1, wherein the piezoelectric material includes comb type electrodes placed at both ends in a length direction of the piezoelectric material, and the thin film having a catalytic action formed between the comb type electrodes.

3. A microreactor according to claim 1, wherein the thin film having a catalytic action is formed of a material selected from the group consisting of metals or metal oxides and organic compound complexes.

4. A microreactor according to claim 3, wherein the thin film having a catalytic action is formed of a plurality of layers.

5. A microreactor according to claim 4, wherein the thin film having a catalytic action has a molybdenum layer adjacent to the surface of the piezoelectric material and a surface layer formed of indium.

6. A microreactor according to claim 1, wherein the thin film having a catalytic action has a thickness of 1 nm to 10 μm.

7. A microreactor according to claim 1, wherein the piezoelectric material comprises a piezoelectric material that generates a Rayleigh wave.

8. A microreactor according to claim 1, wherein the piezoelectric material comprises a piezoelectric material that generates a bulk wave and an SH wave at the same time.
